(19) United States
(12) Patent Application Publication
(10) Pub. No.: US 2005/0058282 A1
(43) Pub. Date: Mar. 17, 2005

(54) Audio signal adaptor

(76) Inventor: Chih-Kai Chang, Taoyuan Hsien (TW)

Correspondence Address: BIRCH STEWART KOLASCH & BIRCH, PO BOX 747, FALLS CHURCH, VA, 22040-0747, US

(21) Appl. No.: 10/661,583

(22) Filed: Sep. 15, 2003

(51) Int. Cl. H04M 1/00; H04M 9/00

(52) U.S. Cl. 379/433.02

(57) ABSTRACT

The present invention provides an audio signal adaptor comprising a space for receiving an optical conversion module. The optical conversion element of the optical conversion module facing the adaptor of the audio signal adaptor allows the circular type 1 plug to fit into the adaptor to form an optical conversion loop with the optical conversion element.

### BACKGROUND OF THE INVENTION

1. The Field of the Invention

The present invention relates to an audio signal adaptor having an optical conversion function, and more particularly, relates to an audio signal adaptor comprising a space to receive an optical conversion module to achieve both telephony signal and optical signal transmission functionalities.

2. Description of the Related Art

In recent years, the adaptor that controls the sound signal in the multimedia system can only receive the audio plug for telephony signal transmission, and when processing the signal transmission by such audio plug, the electromagnetic interference can cause the distortion of signal. Accordingly, some manufacturers proposed to use optical fiber for processing signal transmission. The optical fiber is composed of fiberglass material, capable of transmitting optical signals. A thin fiberglass is capable of replacing a thick conventional cable, and the fiberglass has the advantages of high transmission efficiency and minimum distortion (due to non-existence of electromagnetic interference). Therefore, the fiberglass has taken a very important position in signal transmission technology. The appearance and size of the above audio plug and the circular type 1 plug are same, but the manufacturers usually classify these separately as independent set, thus the space occupation for these element on the circuit board will be correspondingly large, and the assembly work is also correspondingly. Furthermore, to suit the latest trend for electronic products being lighter, thinner and smaller to attract consumers, the circuit board within the electronic product has to be modified into smaller size to meet such requirements. Further rapid advances in technology have led to development of additional features in the electronic products.

Accordingly, as can be seen, in the conventional art, separating the audio plug from the optical fiber plug cannot possibly meet the latest need and trends.

### SUMMARY OF THE INVENTION

Accordingly, in the view of the foregoing, the present inventor makes a detailed study of related art to evaluate and consider, and uses years of accumulated experience in this field, and through several experiments, to create a new audio signal adaptor. The present invention provides an innovated cost effective audio signal adaptor.

The present invention provides an audio signal adaptor comprising a space for receiving an optical conversion module. The optical conversion element of the optical conversion module facing the adaptor of the audio signal adaptor allows the circular type 1 plug to fit into the adaptor to form an optical conversion loop with the optical conversion element.

### BRIEF DESCRIPTION OF THE DRAWING

For a more complete understanding of the present invention, reference will now be made to the following detailed description of preferred embodiments taken in conjunction with the accompanying drawings, in which:

FIG. 1 is a perspective view of a an audio signal adaptor of the present invention;

FIG. 2 is an exploded view of the audio signal adaptor of the present invention;

FIG. 3 is a perspective view of an optical conversion module of the present invention;

FIG. 4 is an exploded view of the optical conversion module of the present invention;

FIG. 5 is a sectional side view showing before assembling of the audio signal adaptor of the present invention;

FIG. 6 is a sectional side view showing while assembling the audio signal adaptor of the present invention;

FIG. 7 is a sectional side view showing after assembling of the audio signal adaptor of the present invention;

FIG. 8 is a sectional side view showing the audio signal adaptor according to one preferred embodiment of the present invention; and

FIG. 9 is a sectional side view showing the audio signal adaptor according to another preferred embodiment of the present invention.

### DETAILED DESCRIPTION OF PREFERRED EMBODIMENTS

Reference will be made in detail to the preferred embodiments of the invention, examples of which are illustrated in the accompanying drawings. Wherever possible, the same reference numbers are used in the drawings and the description to refer to the same or like parts.

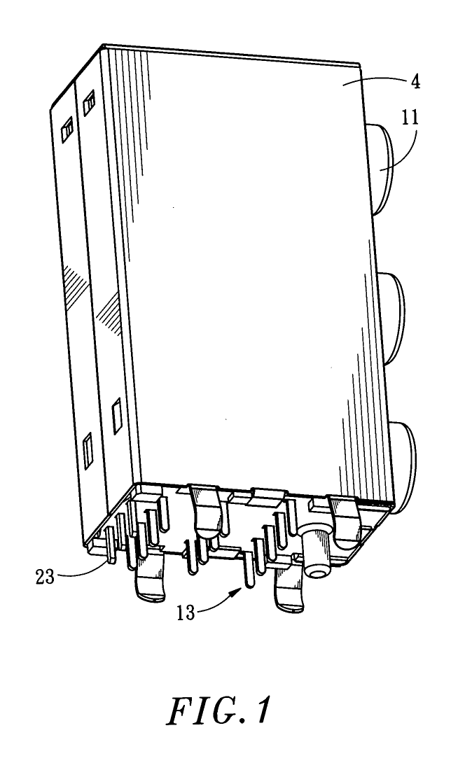

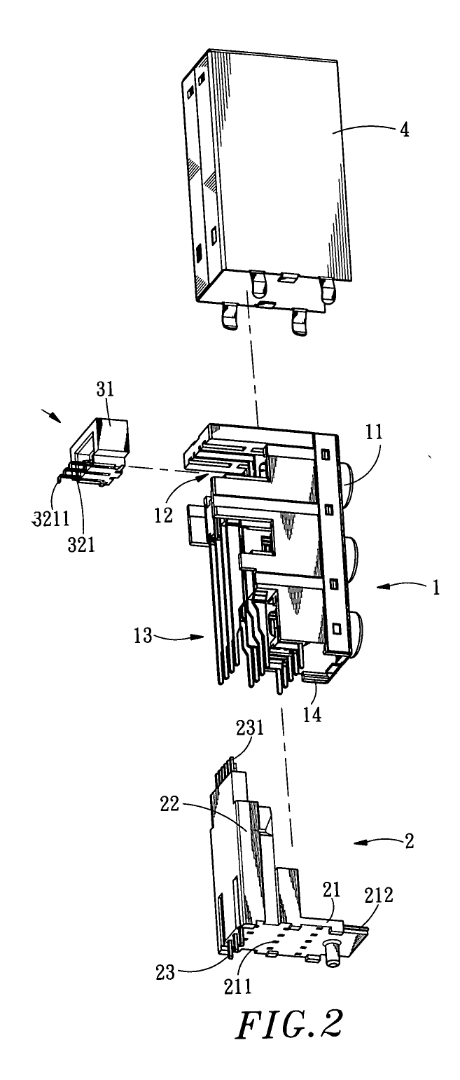

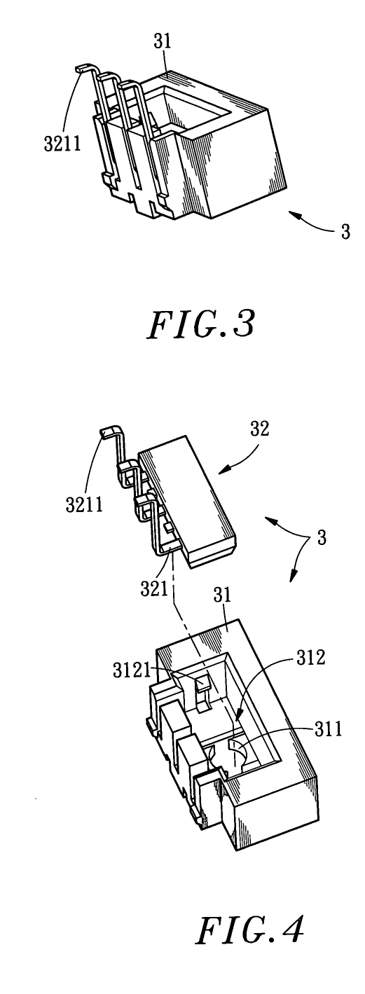

Referring to FIGS. 1, 2, 3 and 4, respectively show the perspective view and exploded view of the audio signal adaptor of the present invention, and the perspective view and exploded view of the optical conversion module of the present invention. As shown in the figures, the audio signal adaptor 1 of the present invention comprises a connector 2 and an optical conversion module 3.

The audio signal adaptor 1 comprises a plurality of adaptors 11 on one side, and a corresponding space 12 is disposed on another side apart from the adaptor 11. A telephony signal terminal 13 is disposed within the space 12. Furthermore, the audio signal adaptor 1 comprises a buckle 14 on a bottom surface.

The connector 2 comprises a button 21, and a base 22 is formed on a side surface of the button 21 for penetrating and fitting a plurality of optical signal terminals 23. The button 21 of the connector 2 further comprises a plurality of groove 211. And the above optical signal terminals 23 has a bent supporting portion 231 formed on one side thereof. Additionally, on the two sides of frontal flange of the button 21 of the connector 2 are extended formed with a buckling portion 212.

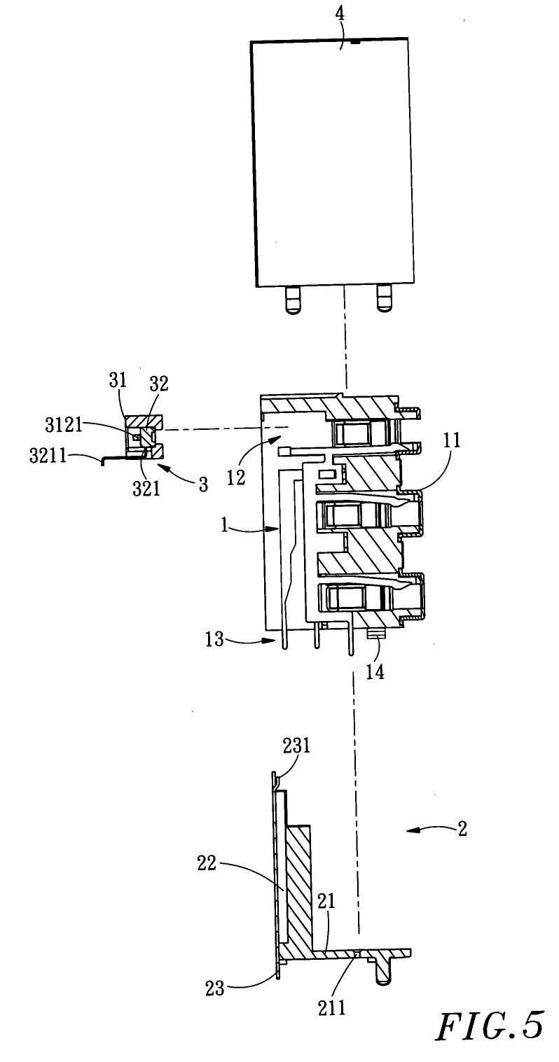

The optical conversion module 3 comprises a base 31, which comprises a positioning hole 311, and on the other side apart from the positioning hole 311 has a space 312 with protruded buckles 3121 formed on two sidewalls. An optical conversion element 32 is positioned in the space 312. Furthermore, the protruded buckles 3121 formed within the space 312 of the base 31 can support the surface of the optical conversion element 32 for positioning, as shown in FIG. 4. The optical conversion element 32 comprises a side extended with a plurality of signal terminals 321 having bent contact portion 3211 at a distal end of each signal terminals.

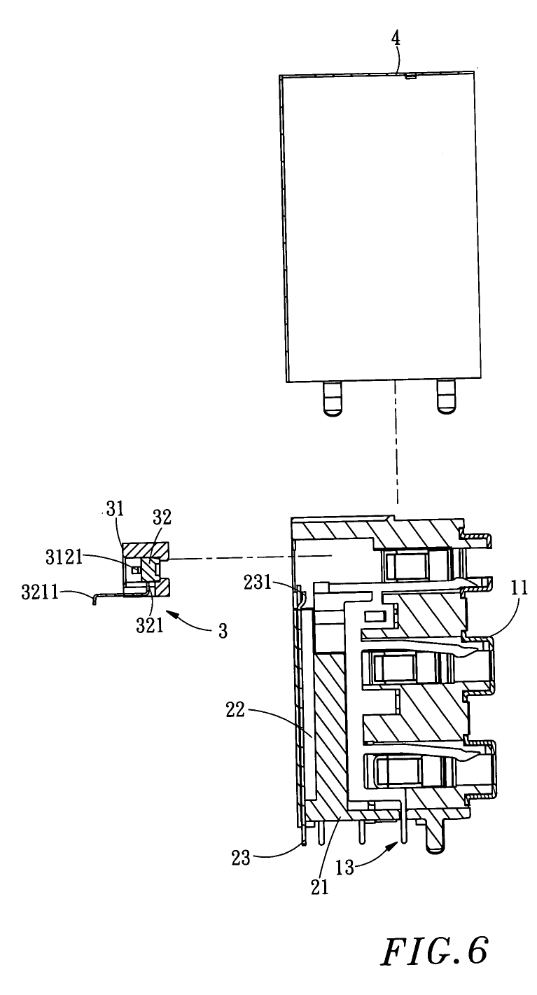

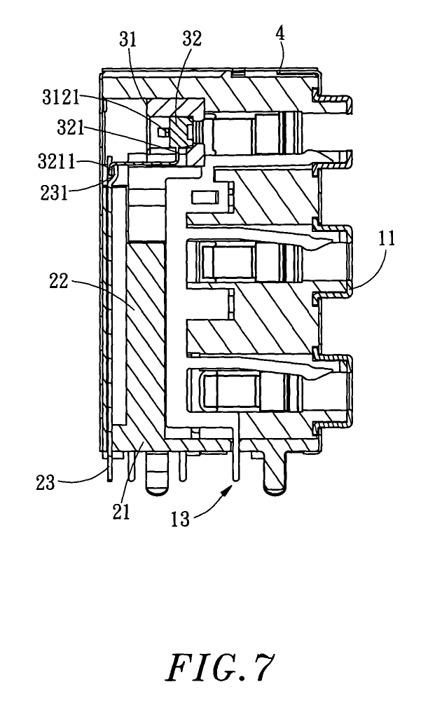

Further, referring to FIGS. 5, 6 and 7, respectively show the sectional side view before assembling, the sectional side view while assembling and the sectional side view after assembling the audio signal adaptor of the present invention. To assemble the audio signal adaptor 1 of the present invention, the telephony signal terminals 13 of the audio signal adaptor 1 is fitted into the plurality of grooves 211 formed at the button 21 of the connector 2, and the buckle 14 extending at the button flange of the audio signal adaptor 1 is resiliently buckled into the buckling portion 212 formed at the frontal flange of button 21 of the connector 2. Next, the base 31 of the optical conversion module 3 is inlayed into the space 12 of the audio signal adaptor 1. Meanwhile, the positioning hole 311 formed at the base 31 of the optical conversion module 3 is positioned facing the adaptor 11 of the audio signal adaptor 1. Correspondingly, the supporting portion 231 of the optical signal terminal 23 will have the electrical connection with the contact portion 3211 of the signal terminal 321. Furthermore, when the above assembly is completed, a case 4 fitted to cover the audio signal adaptor 1 for isolating the electromagnetic signal from the external signals.

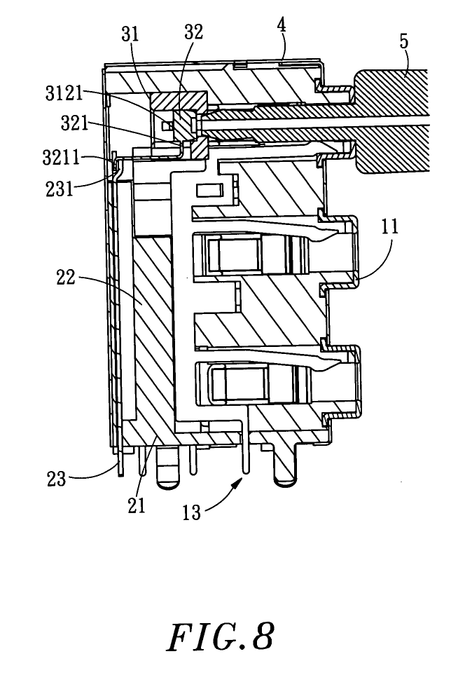

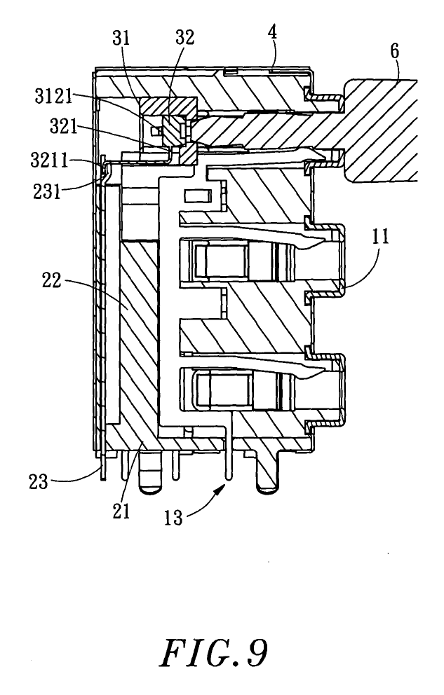

Now referring to FIGS. 8 and 9, respectively show the audio signal adaptor according to one preferred embodiment, and according to another embodiment of the present invention. After the assembly of the audio signal adaptor 1 of the present invention, an adaptor 11 of the audio signal adaptor 1 is fitted into the circular type 1 plug 5, and the terminal of the circular type 1 plug 5 can be inlayed into the positioning hole 311 of the base 31 of the optical conversion module 3 to face the optical conversion element 32 for forming an optical conversion loop. The optical signal terminal 23 of the connector 2 is used for optical signal transmission. Furthermore, when the user inserts the audio plug 6, the telephony signal terminal 13 of the audio signal adaptor 1 can have the electrical contact with the audio plug 6 to enable the audio signal adaptor 1 to have the telephony signal transmission by the signal terminal 13.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

1. An audio signal adaptor having an optical conversion function, comprising:
a plurality of adaptors, located one a side of the audio signal adaptor;
a plurality of spaces, disposed on another side of the audio signal adaptor apart from the adaptors of the audio signal adaptor for fitting telephony signal terminals, wherein said plurality of spaces receive one or more optical conversion modules, said optical conversion module comprises an optical conversion element facing said adaptor to form an optical conversion loop with said adaptor while fitting a circular type 1 plug into said adaptor; and
a connector having a button with a plurality of grooves for fitting telephony signal terminals, located at a rear side of the said audio signal adaptor.

2. The audio signal adaptor according to claim 1, wherein said optical conversion module comprises a base having a positioning hole, and on a side apart from said positioning hole has a space for receiving said optical conversion element.

3. The audio signal adaptor according to claim 2, wherein said space of said base of said optical conversion module comprises protruded buckles on two sidewalls for supporting on a surface of said optical conversion element.

4. The audio signal adaptor according to claim 1, wherein said button of said connector comprises a base for penetrating and fitting a plurality of optical signal terminals, said optical conversion element comprises a plurality of signal terminals, and said signal terminals of said optical conversion element is for having electrical contact with said optical signal terminals of said connector.

5. The audio signal adaptor according to claim 4, wherein said optical signal terminals comprises a bent supporting portion at a side, and said optical conversion element comprises a bent contact portion formed at each distal end of said signal terminals, said bent supporting portion of said optical signal terminals is for positioning said contact portion of said signal terminals.

6. The audio signal adaptor according to claim 1, wherein said button of said connector has a buckling portion extending formed at the flange of the two sides and the two sides of said base of said audio signal adaptor have buckles for buckling to said buckling portion of connector for positioning.

7. The audio signal adaptor according to claim 1, wherein said adaptor of said audio signal adaptor is for inserting an audio plug.

8. The audio signal adaptor according to claim 1, wherein said adaptor of said audio signal adaptor is for inserting a circular type 1 plug.

9. The audio signal adaptor according to claim 1, wherein said audio signal adaptor is covered by a case.
